(19) United States
(12) Patent Application Publication
(10) Pub. No.: US 2005/0117463 A1
(43) Pub. Date: Jun. 2, 2005

(54) Optical disk drive apparatus and data reproducing method thereof

(76) Inventor: Manabu Sasaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/799,628

(22) Filed: Mar. 15, 2004

(30) Foreign Application Priority Data
Dec. 2, 2003 (JP) 2003-402568

(51) Int. Cl. G11B 7/085

(52) U.S. Cl. 369/30.27

(57) ABSTRACT

An optical disk drive apparatus for reading out information from an optical disk 103, having a plural number of information recording layers made up in a direction of rotation axis thereof, through irradiating a light beam upon the recoding layer, wherein there is provided a buffer 106, which is divided into two (2) or more than that of an area, for memorizing the information read out from the optical disk, and a micro-processor 104 supervises an access to an each layer of the information recording layers, so as to make management upon storage of the information, being obtained through pre-reading from each of the recording layer of the optical disk, by managing an access frequency for each information obtained through the supervision thereof, thereby enabling an effective use of the buffer.

### FIELD OF THE INVENTION

The present invention relates to an optical disk drive apparatus for recording or reproducing information by irradiating a light beam upon a disk-like information recording medium, being so-called an optical disk, and it relates, in particular, to an optical disk drive apparatus being suitable for treating or handling the optical disk, on which a plural number of recording layers are formed in a direction of the rotation shaft or axis on one (1) piece of a disk, as well as, a method thereof for reproducing data from such the information recording medium.

### BACKGROUND OF THE INVENTION

In recent years, an optical disk drive apparatus enabling the recording/reproducing of information on an optical information recording medium, such as, the optical disk, etc., is used widely, as a recoding/reproducing apparatus, because of non-contacting and a large capacity thereof, and also obtaining high-speed accessing, and further as that for a recoding medium, which is exchangeable and is low in the cost thereof, for example, to be a recording/reproducing apparatus for a digital audio signal and a digital video signal, as well as, to be an external memory apparatus for a computer.

On the other hand, such the large-sizing is achieved in the capacity thereof, remarkably, in particular, on the optical disk, being the optical information recording disk, which is used in such the apparatus. Thus, in addition to the disk having the conventional structure of only one (1) recording layer (i.e., a single layer), there are further proposed or practiced various kinds of multi-layered optical disks, on which a plural number of information recording layers are formed in the direction of the rotation shaft or axis thereof. Also, accompanying with appearance of such the optical disks, in relation to the optical disk drive apparatus for reading out the information from such the optical disks, a demand is made to shorten a seek time of the optical pickup thereof, for the purpose of searching out data at desire from various data memorized thereon.

Further, though differing from such the optical disk having the multi-layered structure thereon, however relating to an information processing apparatus for use of the conventional optical disk of the single layer structure, in Japanese Patent Laying-Open No. 2002-230795(2002), for example, there is disclosed a technology, for shortening the seek operation time of the optical pickup thereof, being achieved by taking the access frequency to the various data recording on that optical disk into the consideration thereof. Thus, according to this prior art, while obtaining the access frequencies through memorizing the head addresses of the data, which are read out by the optical pickup, an optical pickup completing reading-out operation of the data at random is moved to the position of head address being highest in the access frequency thereof, thereby being in a waiting or standing-by condition thereof.

And also, in Japanese Patent Laying-Open No. Hei 11-16269 (1999), for example, there is disclosed an optical disk apparatus, which can take out the information from an optical disk having the two(2)-layered structure, wherein there is also disclosed a method for reproducing the optical disk, enabling to transmit data swiftly and reduce the number of time or frequency of seeking between the layers thereof, when a read-out command or request is made onto the optical disk having such the structure. With this conventional art, there are provided cache buffer memories for a first layer and a second layer, respectively, thereby increasing up the provability that the data is held within the cache buffer memory with respect to the next coming read-out request onto the second layer, by continuing pre-reading onto the second layer, at the same time, when it is possible to return the data within the cache buffer memory for the first layer back to the destination of issuing a read-out request, responding to that read-out request onto the first layer generating during when memorizing information of the second layer into the cache buffer memory for the information of second layer.

### BRIEF SUMMARY OF THE INVENTION

However, with the conventional arts, in particular, that of the later mentioned, it is not always possible to adopt it into any kind of the optical disks, as it is, but depending upon the structure thereof. In particular, in recent years, there are proposed the optical disks, piling up the layers of a plural number thereof, not only two (2), but more than that, in the direction of rotation axis of the optical disk, however with such the conventional art, also the cache buffer memories must be provided in the number same to that of layers thereof; therefore, it cannot say that it is always a method being suitable to be applied, fully, in particular, in such the cases.

In particular, within the optical disk drive apparatus to be used for handling the information recording medium therein, which has the recording layers in plural number thereof, wherein the seeking of the optical pickup is complex in traveling among the plural number of recording layers in the vertical direction, there are pointed out drawbacks, the possibility comes up to be high in that data are not memorized in the buffer memory, and also that it takes the time longer necessary for reading out the data therefrom, again.

Then, according to the present invention, accomplished by taking the drawbacks in the conventional arts mentioned above into the consideration thereof, an object thereof is to provide a new optical disk drive apparatus, enabling a more effective buffer management therein, even for the optical disks having the recording layers thereon, being made of the layers of equal or more that two (2) in the number thereof, as wall as, a method thereof for reproducing data from such the optical disk.

According to the present invention, for accomplishing the object mentioned above, first there is provided an optical disk drive apparatus, for reading-out information from an optical disk, having a plural number of information recording layers made up in a direction of rotation axis thereof, through irradiating a light beam upon the information recording layer, and for transferring the information read out to a host-computer, responding to a transfer request from said host-computer, comprising: a memory configured to memorize the information read out from said information recording layers; and a processor configured to control said memory, wherein: said processor supervises accesses to each of said plural number of the information recording layers, and memorizes information which follows information, upon which a transfer request is made from said host-computer, into a predetermined area of said memory, upon basis of a frequency of the accesses obtained through the supervision thereof.

Also, according to the present invention, in the optical disk drive apparatus as was mentioned above, it is preferable that said memory comprises said predetermined areas in a plural number thereof, being equal to or greater than two (2), or that said processor further makes management on the access frequency for each of information recorded in each layer of said optical disk, from which the information is read out.

Further, according to the present invention, for accomplishing the object mentioned above, there is also provided a method for reproducing data, comprising, the following steps of: reading out information from an information recording layer, by irradiating a light beam upon an optical disk having a plural number of the information recording layers, being piled up in a direction of rotation axis thereof, in accordance with a transfer request from a host-computer; memorizing the information read out form said information recording layer into a memory; transferring the information memorized in said memory to said host-computer; and supervising an access to an each layer of said plural number of the information recording layers, and memorizing information, which follows information, upon which the transfer request is made from said host-computer, into a predetermined area of said memory, upon basis of a frequency of the accesses obtained through the supervision thereof.

And also, according to the present invention, in the method for reproducing data as mentioned above, it is preferable that said memory comprises said predetermined areas in a plural number thereof, being equal to or greater than two (2), or that the supervision on the access frequency is made for an each layer of those layers of said optical disk, from which the information is read out.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a view of showing a flowchart, for explaining a buffer management function obtained in an optical disk drive apparatus, according to one embodiment of the present invention;

FIG. 2 is a block diagram for showing the entire structure of the optical disk drive apparatus, according to the embodiment of the present invention;

FIG. 3 is a view for showing inner areas divided within a buffer of the optical disk drive apparatus, according to the embodiment of the present invention;

FIG. 4 is a view for explaining the operation in the optical disk drive apparatus mentioned above, according to one embodiment of the present invention; and

FIG. 5 is also a view for explaining the operation in the optical disk drive apparatus mentioned above, according to the embodiment of the present invention.

### DESCRIPTION OF THE PREFERRED EMBODIMENTS

Hereinafter, embodiments according to the present invention will be fully explained by referring to the attached drawings.

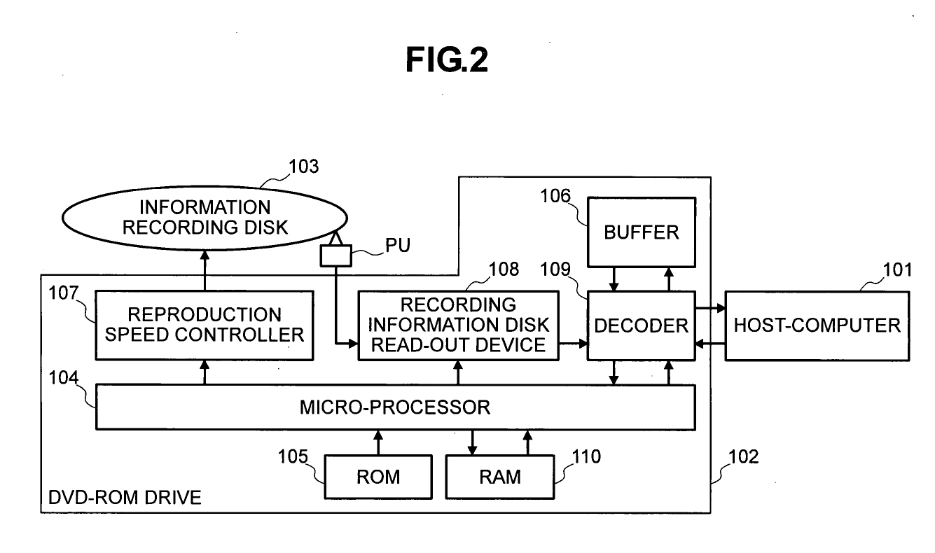

First of all, FIG. 2 attached herewith is the block diagram for showing the entire structure of an optical disk drive apparatus, being able to reproduce information recorded on a multi-layered optical disk, according to one embodiment of the present invention.

In the figure, an information recording disk 103 is made of the so-called the multi-layered optical information recording disk. It is about disk-like in an outer configuration thereof, and is formed with an information recording layer, being made of a plural number of layers (i.e., layers of an integer number, being equal to two (2) or more than that), laminating or piling up in the direction of rotation axis thereof; thus, showing an optical information recording medium being able to record/reproduce the recorded information through irradiation of a light beam, such as, a laser light beam, etc., upon each of the layers.

The information recording disk 103 is mounted or loaded into an inside of an optical disk drive apparatus 102, according to one embodiment of the present invention, through a tray or the like, though not shown in the figure, which is provided in a portion thereof, and it is recorded/reproduced of the information by an optical pickup PU, having a light generating source, such as a semiconductor laser, etc., an optical system, such as, an objection lens and a collimator, etc., and further a driving system or mechanism for performing a focusing and a tracking thereof. Namely, a signal read out by this optical pickup PU is conducted to an information recording disk read-out device 108, and then it is treated with a predetermined signal processing thereupon within a decoder 109, and thereafter the optical disk drive apparatus 102 conducts the transition of data between a host-computer 101 connected via an interface, for example.

Also, in the figure, a reproduction speed controller portion 107 controls a disk motor, for driving the optical information recording disk 103, rotating at a predetermined revolution velocity thereof. Also, a buffer 106 is a memory that is connected to the decoder 109 mentioned above. And, a micro-processor 104 is connected with each of the constituent parts or elements mentioned above, thereby controlling the operations thereof, respectively. In this figure, as a memory means for calculation processing thereof, there are provided an un-rewritable read only memory (ROM) 105 and a rewritable random access memory (RAM) 110, in the form of the so-called the exterior memories thereof.

Although not illustrated in the figure herein, however it would be obvious that the optical pickup PU mentioned above can reproduce the recording information from an each layer of the information recording layers, through controlling the optical system and the driving system, etc., of the pickup mentioned above, upon instructions from the micro-processor 104, with respect to the optical information recording disk 103 being made up with the plural number of layers piled up or laminated in the direction of rotation shaft thereof, or record information thereon. Also, with such the structure mentioned above, a request from the host-computer 101 is obtained through the decoder, with an aid of the micro-processor 104 mentioned above, and the data recorded on an each layer of the information recording disk 103, which is made up with the plural number of layers, is read out with using the information recording disk read-out device 108, and then, after being stored within the buffer 106 through the decoder 109, temporally, it is transmitted or transferred to the host-computer 101.

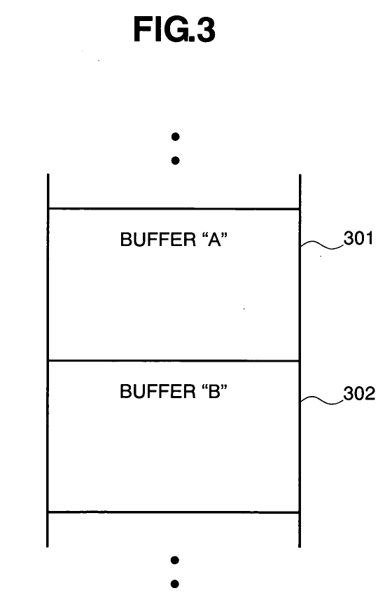

Also, FIG. 3 attached herewith shows the inner structure of the buffer 106 mentioned above, and as is apparent from this figure, this buffer is divided into plural area, two (2) areas; i.e., a buffer area A 301 and a buffer area B 302, according to the present embodiment. However, according to the present embodiment, the number of those areas divided within this buffer, not depend upon the number of the information recording layers which are built up by piling them up on the optical information recording disk 103, but it can be set to an arbitrary number, as far as it is equal or greater than two (2). Also, according to this embodiment, the buffer are A 301 is set to be an area for storing the data therein, which are accessed frequently, on the other hand, the buffer are B 302 an area for data of general purpose, which is accessed at a normal frequency.

And, in the RAM 110 mentioned above, together with an “information about a frequency of read-out requests (i.e., a request frequency counter)” for each layer of the information recording disk 103 mentioned above, there is also memorized a so-called “layer-buffer area relation information”; thus, building up a relationship of the information stored in the plural number of areas on the buffer 106, e.g., the buffer area A 301 and the buffer area B 302, and the information read out from the number of the layers of the disk 103. However, it is assumed that, those information about a number of times or frequency of the read-out requests (i.e., the request number counter) and also the layer-buffer area relation information memorized in the RAM 110 are set back to the conditions of “zero (0)” and “no relationship”, again, for example, when an electric power 102 is turned ON for the optical disk drive apparatus mentioned above, or when the information recording disk loaded in the apparatus is changed over. Further, those information about a frequency of the read-out requests (i.e., the request frequency counter) and also the layer-buffer area relation information are provided for each of the layer on the information recording medium 103, i.e., in the number being same to that of the layers.

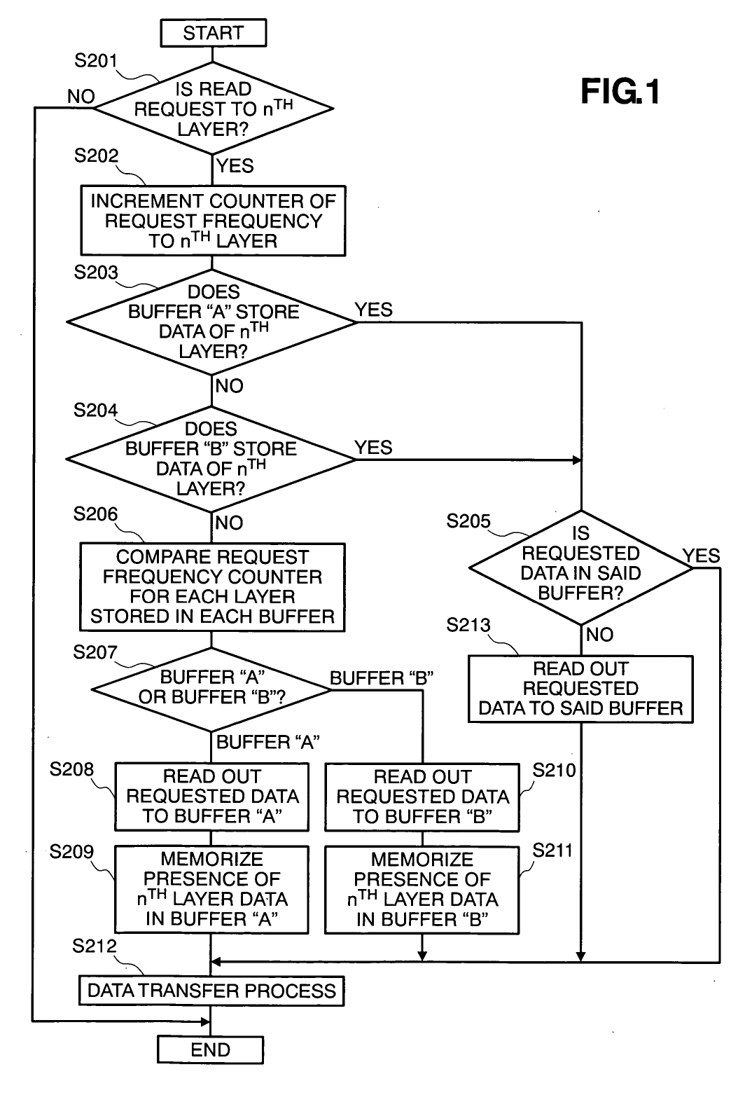

Following to the above, hereinafter, explanation will be given about the operation of the optical disc drive apparatus 102 according to the present embodiment, the structure of which was explained in the above, by referring to the flowchart shown in FIG. 1 attached herewith. However, the steps according to the flowchart shown in FIG. 1 are provided for the purpose of achieving a buffer management function for storing data of the layer accessed at high frequency, with a supervisory on the access frequency made to each layer of the information recording disk 103, and they are stored in the ROM 105 to be executed by the micro-processor 104 mentioned above. Also, as was mentioned previously, though the layers formed on the information recording disk 103, which is loaded into the optical disk drive apparatus 102, may be any number thereof, but being equal to or greater than two (2), however herein, explanation will be given on the case where the number of lays is three (3), for convenience of the explanation thereof.

In FIG. 1 mentioned above, first of all, it is determined that the read-out request from the host-computer is made onto which layer of the information recording disk 103. For example, in the case where it is made up with the three (3) layers thereof, while changing “n” in the step S201 to “1”, “2” and “3”, sequentially, it is determined that the read-out request is made onto which layer thereof. And as a result of this determination, the process is ended if it is determined that the read-out request made from the host-computer is not to any one of the layers of the information recording disk 103 (i.e., see “No” in the figure). On the other hand, if it is determined that the read-out request from the host-computer 101 is made onto any of the information recording disk 103 (see “Yes” in the figure), then the process advances into the next step S202.

Next, in the step S202, the information about the frequency of read-out request mentioned above is incremented, which is provided within the RAM 110, i.e., a request frequency counter. For example, in the case where the read-out request is issued to the third layer, the request frequency counter is incremented. And, in a step S203, it is determined on whether there is memorized data of the n^{th} layer or not, within the one of the buffer 106 mentioned above; e.g., the buffer area A 301, with using the information of the layer-buffer area relation information provided within the RAM 110 mentioned above.

Thereafter, when the determination is “Yes” that is made in the step 203 mentioned above, the process advances into a step S205, and there is determined on whether the requested data is memorized or not within said the buffer area A 301. As a result of this, when determined that the requested data is memorized therein (i.e., “Yes”), the request data memorized within said the buffer area A 301 is transferred to the host-computer 101 (step S212), thereby stopping the process. On the other hand, if determined that the requested data is not therein (i.e., “No”) in the step S205 mentioned above, then together with the information requested from the host-computer, the pre-read information following to this is read out, in a step S213, with using the information recording disk read-out device 108. And, they are decoded within the decoder 109, to be stored in said the buffer, and thereafter the process advances to the step S212 mentioned above. Namely, after conducting transmission of the requested data read out from the information recording disk 103 to the host-computer 101, and then the process is ended.

Herein, in the case of “No” in the step S203 mentioned above; thus, it is determined that the data of the n^{th} layer is not memorized within the buffer area A 301, being the one of two within the buffer 106 mentioned above, the process advances to the step S204, and then it is determined therein on whether the requested data is memorized or not in the other area of the buffer 106; thus, in the buffer area B 302. Further, when it is decided to be “Yes”, as a result of the determination in the step S204, the process advances to the step S205, and the same processes are repeated thereon; thus, when it is memorized in the other buffer area B 302, the requested data is transferred to the host-computer 101, but on the other hand if no, the requested data is read out from the information recording disk 103, and it is transferred to the host-computer 101.

And, in the case of “No” in the step S204 mentioned above; thus, it is determined that the requested data is not memorized in any one of the areas of the buffer 106, e.g., neither within the buffer area A 301 nor the buffer area B 302, then the step advances to a next step 206, wherein the information are obtained about the frequency of read-out requests (i.e., the request frequency counter) for each of the layers (i.e., the first layer, the second layer, or the third layer), which are stored in each of the buffer areas (i.e., the buffer area A 301 and the buffer area B 302), and they are compared with. Namely, then, in a step S207, the obtained values of the request frequency counters are compared with, for the each layer, thereby for determining on, into which area the information read out from the information recording disk 103 should be stored, between the buffer area A 301 (i.e., the area for use of the data which is accessed frequently) and the buffer area B 302 (i.e., the area for use of the data of general use).

Thereafter, in a case when it is determined to be stored into the “buffer A” in the step S207, the process advances to a step S208, but on the other hand, it advances to a step S210, in a case when it is determined to be stored in the “buffer B”.

Namely, in the step S208 mentioned above, for pre-reading the data requested from the host-computer 101 and the data following thereto, the pre-read information is read out from the information recording disk 103 with using the information recording disk read-out device 108, and further it is decoded within the decoder 109, thereafter, it is stored into one area of the buffer 106 mentioned above; thus, being read out and stored into the buffer area A 301. And in the step S209, it is memorized the fact that the data of the n^{th} layer is memorized in the buffer area A 301, and further in the step S212 mentioned above, the requested data that is read out is transferred to the host-computer 101, and then the process is ended. Or, alternately, in a step 210, for pre-reading the data requested from the host-computer 101 and the data following thereto, the pre-read data is read out from the information recording disk 103 with using the information recording disk read-out device 108, and further it is decoded within the decoder 109, to be stored in one of the buffer 106; i.e., into the buffer area B 302. And in a step 211, it is memorized that the data of the n^{th} layer is memorized in the buffer area B 302, and further in the step S212 mentioned above, the requested data read out is transferred to the host-computer 101, and then the process is ended. Namely, in the steps 209 and 211, renewal is made on the layer-buffer area relation information, which are memorized within the RAM 110 mentioned above.

As was explained in the above, with the optical disk drive 102 apparatus according to the present embodiment, since it is possible to transfer the information (i.e., the data requested from the host-computer) about that, which is stored within any area of that buffer 106; i.e., the buffer area A 301 or the buffer area B 302, directly, therefore enabling the data transmission with swiftness or quickness. Also, about the information, which is not stored in any one of those areas, it is read out from the information recording disk 103 to be transferred thereto, and at the same time, supervision is made on the access frequency of the information, with corresponding to the layer where that information is recorded, i.e., for each of the layers; therefore, it is possible to achieve the quick transfer of data, with the provision of the buffer management function for pre-reading data of the layer at high frequency.

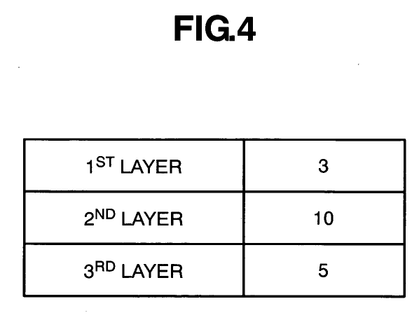

For example, in a case where a request is made from the host-computer 101 mentioned above, upon the data recorded on the first layer of the information recording disk 103 having the three(3)-layered structure mentioned above, for example, such the requested data is read out from the information recording disk 103, if that data is not stored within any one of the buffer area A 301 and the buffer area B 302 of the buffer 106, however in such case, the pre-read data is stored thereafter, into either the buffer area A 301 or the buffer area B 302, but in this instance, the data pre-read from the first layer is read into the buffer area B 302 to be stored therein, in a case when the count values of request frequency are as shown in FIG. 4, for each one of the layers thereof, which is obtained in the step S206 mentioned above.

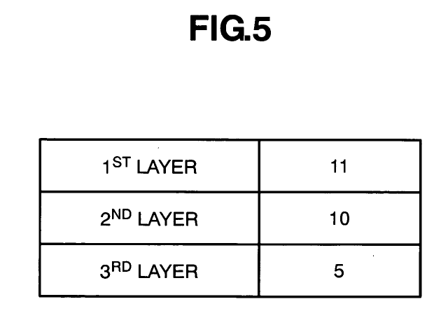

On the other hand, in a case when the count values of request frequency are as shown in FIG. 5, for each one of the layers thereof, which is obtained in the step S206 mentioned above, the data pre-read from the first layer is read into the buffer area A 301, to be stored therein. However, for the buffer areas divided within the buffer 106 mentioned above, it is not always necessary to be set fixedly in the sizes thereof, but the sizes of those buffer areas may be altered in accordance with the count value of the requests. In a case where a ratio, such as, 9 to 1 (9:1), is obtained from the values of the frequency counters, between the data having high generation frequency and the data of general use, for example, it is possible to determine the ratio of sizes of the buffer area A 301 and the buffer area B 302 to be 9 to 1 (9:1), too.

As was mentioned above, with the optical disk drive apparatus according to the present embodiment, it is possible to use the buffer provided therein, effectively, through supervising the access frequencies for each layer, as well as, pre-reading data that is accessed at high frequency thereof, within the function of pre-reading the information recording disk having a plural number of layers thereon.

Furthermore, in the explanation given in the above, the pre-reading function of the information recording disk, for example, to read into data, including the information, upon which the request is made, and also that following thereto in a predetermined region or area, to be stored into the buffer, and with this, to store the data into the buffer in advance, which can be expected high in the possibility of being accessed. Also, in the embodiment mentioned in the above, the number of layers of the information recording disk is explained to be three (3), however, the present invention should not be restricted only thereto, but it may be applied into a case where the number of layers is equal to or greater than two (2), or when it is a hundred (100), for example. In addition thereto, though the explanation was given only onto the example, in which the buffer is divided into two (2) areas, however in this aspect, it may be divided into a number more than two (2). Further, in addition thereto, though the explanation was given that the data of one layer is stored into only one buffer area in the above, however it is possible to store the data into the buffer, by dividing it into a certain number of data areas, so as to be assigned or distributed to the corresponding area, or the data covering over the layers can be stored into the same buffer area.

As was fully explained in the above, according to the present invention, it is possible to provide the optical disk drive apparatus and the reproducing method thereof, enabling an effective use of the buffer, and also transfer of data without delay or retardation even with the information recording optical disk having the plural number of recording layers thereon, with supervising the access frequency for each layer, and conducting the pre-reading of the data of the high frequency with using a result of this supervision thereof.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

1. An optical disk drive apparatus, for reading-out information from an optical disk, having a plural number of information recording layers made up in a direction of rotation axis thereof, through irradiating a light beam upon the information recording layer, and for transferring the information read out to a host-computer, responding to a transfer request from said host-computer, comprising:
a memory configured to memorize the information read out from said information recording layers; and
a processor configured to control said memory, wherein:
said processor supervises accesses to each of said plural number of the information recording layers, and memorizes information which follows information, upon which a transfer request is made from said host-computer, into a predetermined area of said memory, upon basis of a frequency of the accesses obtained through the supervision thereof.

2. The optical disk drive apparatus, as described in the claim 1, wherein said memory comprises said predetermined areas in a plural number thereof, being equal to or greater than two (2).

3. The optical disk drive apparatus, as described in the claim 1, wherein said processor further makes management on the access frequency for each of information recorded in each layer of said optical disk, from which the information is read out.

4. A method for reproducing data, comprising, the following steps of:
reading out information from an information recording layer, by irradiating a light beam upon an optical disk having a plural number of the information recording layers, being piled up in a direction of rotation axis thereof, in accordance with a transfer request from a host-computer;
memorizing the information read out form said information recording layer into a memory;
transferring the information memorized in said memory to said host-computer; and
supervising an access to an each layer of said plural number of the information recording layers, and memorizing information, which follows information, upon which the transfer request is made from said host-computer, into a predetermined area of said memory, upon basis of a frequency of the accesses obtained through the supervision thereof.

5. The method for reproducing data, as described in the claim 4, wherein said memory comprises said predetermined areas in a plural number thereof, being equal to or greater than two (2).

6. The method for reproducing data, as described in the claim 4, wherein the supervision on the access frequency is made for an each layer of those layers of said optical disk, from which the information is read out.
